(19) United States
(12) Patent Application Publication
(10) Pub. No.: US 2006/0174622 A1
(43) Pub. Date: Aug. 10, 2006

(54) Electrical generating system using solar energy and gas turbine

(76) Inventor: Mark Skowronski, Tustin, CA (US)

Correspondence Address: SHELDON & MAK, INC, 225 SOUTH LAKE AVENUE, 9TH FLOOR, PASADENA, CA, 91101, US

(21) Appl. No.: 11/054,740

(22) Filed: Feb. 9, 2005

(51) Int. Cl. F03G 6/00; B60K 16/00; B60L 8/00

(52) U.S. Cl. 60/641.8

(57) ABSTRACT

An apparatus for generating electricity using both solar energy and a gas turbine includes (a) a gas turbine electric generator; (b) a solar energy collector array; (c) a vaporizer for vaporizing a working fluid liquid, such as water, using thermal energy derived from the solar energy collector array; (d) one or more superheaters for superheating working fluid vapor produced in the vaporizer; and (e) a working fluid vapor turbine electric generator, such as a steam turbine electric generator, the working fluid vapor turbine electric generator being driven by the superheated working fluid vapor. The apparatus is configured such that all of the working fluid vapor exiting the one or more superheaters is that which is produced in the vaporizer.

### FIELD OF THE INVENTION

This invention relates generally to electrical generating systems and, especially, to electric generated systems combining a solar energy field and a gas turbine electric generator.

### BACKGROUND OF THE INVENTION

Solar thermal generation has the ability to generate clean, on-peak firm energy when used in conjunction with a fossil fuel for backup. Solar thermal generation is the only renewable source of energy which can be so easily hybridized and provide the premium energy desired by summer peaking utilities. Solar powered generation essentially follows the energy load of summer peaking utilities, thereby providing the on-peak energy when it is needed most.

A typical solar thermal generation system is illustrated in FIG. 1 and consists of a traditional steam Rankine cycle with gas assist to provide energy during cloudy or rainy days and for emergency generation. In the system illustrated in FIG. 1, thermal energy is collected by a solar energy array and transferred to a heat absorbing transfer fluid, such as an oil. The heated oil or other transfer fluid circulates in thermal contact with a working fluid liquid, typically water, in a vaporizer, such as in a water boiler. In the vaporizer, the working fluid liquid is vaporized to a working fluid vapor. (Where the working fluid liquid is water, the working fluid vapor is steam.) The working fluid vapor produced in the vaporizer is thereafter further heated in one or more superheaters and is then used to generate electricity by driving a working fluid vapor turbine electric generator, such as a steam turbine electric generator. Upon exit from the working fluid vapor turbine electric generator, the working fluid vapor is condensed, deaerated, heated in a vaporizer preheater and recycled back to the vaporizer. In a typical solar thermal generation facility, the heat required by the one or more superheaters is provided by a fossil fuel burning heater.

Although simple and reliable, such solar thermal generation facilities are inefficient and cannot compete, in most cases, with traditional fossil fuel generated electrical energy.

Attempts have been made to increase the efficiency of solar thermal generating facilities by combining such facilities with a combustion turbine electric generator system. Such an attempt is a system called an Integrated Solar Combined Cycle System (“ISCCS”), which is illustrated in FIG. 2. In an ISCCS, the traditional steam Rankine cycle of the solar thermal generation unit is combined with the Brayton cycle of a combustion turbine generating facility. The result is the complex system illustrated in FIG. 2. In an ISCCS, working fluid vapor is produced in a working fluid vaporizer using heat developed in a thermal array. The working fluid vapor is then transferred to a complex piece of equipment called a heat recovery steam generator. The heat recovery steam generator not only provides super heat for the working fluid vapor produced in the vaporizer, but also produces additional working fluid vapor in one or more additional vaporizers. Heat for preheating recycled working fluid condensate is also provided by the heat recovery steam generator. The heat recovery steam generator produces both a high pressure stream of working fluid vapor, a low pressure stream of working fluid vapor and, depending on the system configuration, an intermediate pressure stream of working fluid vapor (not shown in FIG. 2). These working fluid vapor streams are utilized in a complex working fluid vapor turbine electric generator to produce electricity. As illustrated in FIG. 2, exhaust streams from the high pressure and low pressure working fluid vapor streams are returned from the working fluid vapor turbine electric generator to the heat recovery system generator in separate lines.

The ISCCS system, unfortunately, has been poorly received in the market because of several problems. First of all, the solar fractional portion of the total electric energy generated is very low. Thus, most ISCCS plants cannot qualify for various tax and other economic incentives provided by local governing bodies for renewable energy producing facilities. Also, the heat recovery steam generator is inherently inefficient, since it must be carefully designed as a combined unit and cannot be efficiently operated when there is no solar heat addition. Finally, the ISCCS is highly complex in design and operation, and is, for that reason, expensive to build, maintain and operate.

Accordingly, there is a need for a new system for utilizing solar power which avoids the aforementioned problems with the prior art.

### SUMMARY OF THE INVENTION

The invention satisfies this need. The invention is an apparatus for generating electricity comprising (a) a gas turbine electric generator for generating a first quantity of electricity and yielding a hot exhaust gas; (b) a solar energy collector array for collecting solar energy and transferring that solar energy to a solar energy transfer fluid; (c) a vaporizer in fluid communication with a source of a working fluid liquid and in thermal communication with the solar energy transfer fluid such that working fluid liquid disposed within the vaporizer can be heated to a working fluid vapor by thermal contact with the solar energy transfer fluid; (d) one or more superheaters in fluid communication with the vaporizer for receiving working fluid vapor generated in the vaporizer, the one or more superheaters being in thermal communication with the exhaust gas from the gas turbine electric generator so that working fluid vapor received into the superheater can be further heated in the superheater; and (e) a working fluid vapor turbine electric generator, the working fluid vapor turbine electric generator being in fluid communication with the working fluid vapor from the one or more superheaters so that working fluid vapor from the one or more superheaters can be used to drive the working fluid vapor turbine electric generator, thereby to generate a second quantity of electricity. In the invention, all of the working fluid vapor exiting the one or more superheaters is that which is produced in the vaporizer.

The invention is also a method for utilizing the apparatus of the invention comprising the steps of (a) combusting a fuel gas in the gas turbine electric generator to produce a hot exhaust gas and a first quantity of electricity; (b) heating the solar energy transfer fluid with solar energy collected in a solar collector array; (c) heating a working fluid liquid in the vaporizer with the solar energy transfer fluid to vaporize the working fluid liquid, thereby producing a working fluid vapor at a first working fluid vapor temperature; (d) transferring the working fluid vapor to the one or more superheaters and therein heating the working fluid vapor with the exhaust gas from the gas turbine electric generator to heat the working fluid vapor to a second working fluid vapor temperature which is higher than the first working fluid vapor temperature; (e) driving the working fluid vapor turbine electric generator with the working fluid vapor after it has been heated to the second working fluid vapor temperature to yield a second quantity of electricity and exhaust working fluid vapor having a third temperature which is lower than the second working fluid vapor temperature. In the invention, all of the working fluid vapor heated to the second working fluid vapor temperature in step (d) is produced in step (c).

### DRAWINGS

These and other features, aspects and advantages of the present invention will become better understood with reference to the following description, appended claims and accompanying drawings where:

FIG. 1 is a simplified flow diagram of a solar thermal generation system of the prior art;

FIG. 2 is a simplified flow diagram of an Integrated Solar Combined Cycle System of the prior art; and

FIG. 3 is a simplified flow diagram of an electricity generating system having features of the invention.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

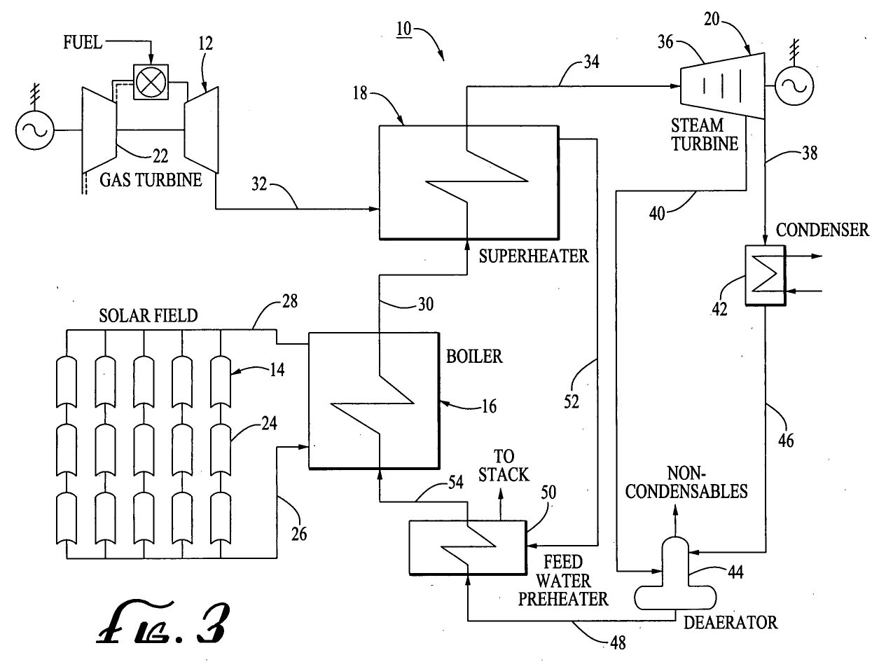

The invention is an apparatus 10 for generating electricity and a method for operating such apparatus 10. The apparatus 10 comprises a gas turbine electric generator 12, a solar energy collector array 14, a vaporizer 16, one or more superheaters 18 and a working fluid vapor turbine electric generator 20. In a typical embodiment, the working fluid liquid is water, the working fluid vapor is steam, the vaporizer 16 comprises one or more boilers and the working fluid vapor turbine electric generator 20 is a steam turbine electric generator. Such a typical embodiment is illustrated in FIG. 3.

With respect to the embodiment illustrated in FIG. 3, the gas turbine electric generator 12 is a typical gas turbine electric generator 12 known to those in the art. The gas turbine electric generator 12 uses the hot exhaust gas from the combustion of a fuel gas to drive a turbine 22 and to thereby generate a first quantity of electricity and produce a hot exhaust gas.

The solar energy collector array 14 comprises a large plurality of solar energy collectors 24 of the type generally known in the art. In the solar energy collector array 14, heat gathered by the plurality of solar energy collectors 24 is transferred to a solar energy transfer fluid such as an oil. Typical solar energy transfer fluids are mineral oil for temperatures up to 600° F. and diphenyl oxide/biphenyl-based products for temperatures exceeding 6006F. As illustrated in FIG. 3, heated solar energy transfer fluid is cycled to the vaporizer 16 (labeled “BOILER” in the embodiment illustrated in FIG. 3) via a hot solar energy transfer fluid line 26. Cooler solar energy transfer fluid is recycled from the vaporizer 16 to the solar energy collector array 14 via a cooler solar energy transfer fluid line 28.

In the vaporizer 16, a working fluid liquid (water in the embodiment illustrated in FIG. 3) is vaporized by thermal contact with the hot solar energy transfer fluid. The resulting working fluid vapor (steam in the embodiment illustrated in FIG. 3) is transferred at a first working fluid vapor temperature from the vaporizer 16 to the one or more superheaters 18 via a working fluid vapor line 30. Where the working fluid is steam, the first working fluid vapor temperature is typically between about 500° F. and about 600° F. The vapor can be saturated or superheated.

In the one or more superheaters 18, incoming working fluid vapor from the vaporizer 16 is further heated by the hot exhaust gas from the gas turbine electric generator 12 (which is transferred to the one or more superheaters 18 via a hot exhaust gas line 32). Within the one or more superheaters 18, the working fluid vapor is heated to a second working fluid vapor temperature which is higher than the first working fluid vapor temperature. Where the working fluid vapor is steam, such second working fluid vapor temperature is typically between about 800° F. and about 1000° F.

Preferably, at least about 90% of the hot exhaust gas from the gas turbine electric generator 12 is used in the one or more superheaters 18 to superheat the working fluid vapor to the second working fluid vapor temperature, more preferably at least about 95% of the hot exhaust gas, and most preferably about 100% of the hot exhaust gas.

The working fluid vapor is thereafter transferred from the one or more superheaters 18 to the working fluid vapor turbine electric generator 20 via a turbine driving vapor line 34. Within the working fluid vapor turbine electric generator 20, the superheated working fluid vapor from the one or more superheaters 18 is used in a working fluid vapor turbine 36 (labeled “STEAM TURBINE” in the embodiment illustrated in FIG. 3) to drive the turbine 36 so as to produce a second quantity of electricity.

After being used to drive the working fluid vapor turbine electric generator 20, low pressure working fluid vapor, now at a third working vapor fluid temperature, less than that of the second working fluid vapor temperature, is removed from the working fluid vapor turbine 36, condensed, deaerated and recycled to the vaporizer 16. In the embodiment illustrated in FIG. 3, the low pressure working fluid vapor is removed from the working fluid vapor turbine 36 in two streams, a first low pressure stream in a first low pressure line 38 and a second low pressure stream in a second low pressure line 40. The low pressure working fluid vapor in the first low pressure line is condensed by thermal contact with a cooling fluid in a condenser 42. The resulting condensate is transferred to a deaerator 44 via a condensate line 46. The condensate in the condensate line and the low pressure working fluid vapor in the second low pressure line are contacted with one another in the deaerator 44 in such a way so as to drive off non-condensible gases.

The resulting deaerated condensate is removed from the deaerator 44 via a deaerated condensate line 48 and is transferred to a preheater 50 (labeled “FEEDWATER PREHEATER” in the embodiment illustrated in FIG. 3). In the preheater 50, the deaerated condensate is heated by thermal contact with low temperature exhaust gas (which was originally generated in the gas turbine electric generator 12 and which has been exhausted from the one or more superheaters 18 to the preheater 50 via a low temperature exhaust gas line 52). Typically, the deaerated condensate is heated in the preheater 50 with most of the low temperature exhaust gas from the one or more superheaters 18, preferably with essentially all of the low temperature exhaust gas, and, most preferably with all of the low temperature exhaust gas. The exhaust gas can thereafter be exhausted to the atmosphere from the preheater 50.

The resulting preheated deaerated condensate is then recycled from the preheater 50 to the vaporizer 16 via a preheated condensate line 54.

A critical feature of the invention is that the apparatus 10 is configured such that all of the working fluid vapor exiting the one or more superheaters 18 is that which is produced in the vaporizer 16.

The invention is also a method of using the aforementioned apparatus 10 for generating electricity. The method comprises the steps of (a) combusting a fuel gas in the gas turbine electric generator 12 to produce a hot exhaust gas and a first quantity of electricity; (b) heating the solar energy transfer fluid with solar energy collected in a solar collector array; (c) heating a working fluid liquid in the vaporizer 16 with the solar energy transfer fluid to vaporize the working fluid liquid, thereby producing a working fluid vapor at a first working fluid vapor temperature; (d) transferring the working fluid vapor to the one or more superheaters 18 and therein heating the working fluid vapor with the exhaust gas from the gas turbine electric generator 12 to heat the working fluid vapor to a second working fluid vapor temperature which is higher than the first working fluid vapor temperature; (e) driving the working fluid vapor turbine electric generator 20 with the working fluid vapor after it has been heated to the second working fluid vapor temperature to yield a second quantity of electricity and exhaust working fluid vapor having a third temperature which is lower than the second working fluid vapor temperature. In the invention, all of the working fluid vapor heated to the second working fluid vapor temperature in step (d) is produced in step (c).

The invention provides the utility user with many important advantages over systems of the prior art. First and foremost is the increased overall efficiency of a solar energy production facility. Secondly, the invention provides the utility with the ability to qualify for tax and other economic incentives based upon facilities producing a high percentage of renewable energy. Typically, energy produced by the invention is greater than 50% solar, and can be greater than 75% solar. Thirdly, the apparatus of the invention is simple and inexpensive to build, operate and maintain. Fourthly, the invention provides the utility with a great deal of flexibility, both in initial design and in subsequent operation. In this regard, the invention provides the utility with the unique ability to mix and match several different gas combustion electrical generators with a solar field to meet different operating criteria and different solar fractions. This is because, unlike the ISCCS, the system of the invention is not bound by a single integrated design. The solar field and the gas combustion electrical generator can be efficiently operated without the other when necessary. This is virtually impossible in an ISCCS, where both the solar field and the gas turbine electric generator must be working together. Moreover, the utility can design the apparatus of the invention over a wide range of temperatures and pressures to meet different operating criteria and solar fractions, without markedly effecting overall efficiency.

### EXAMPLE

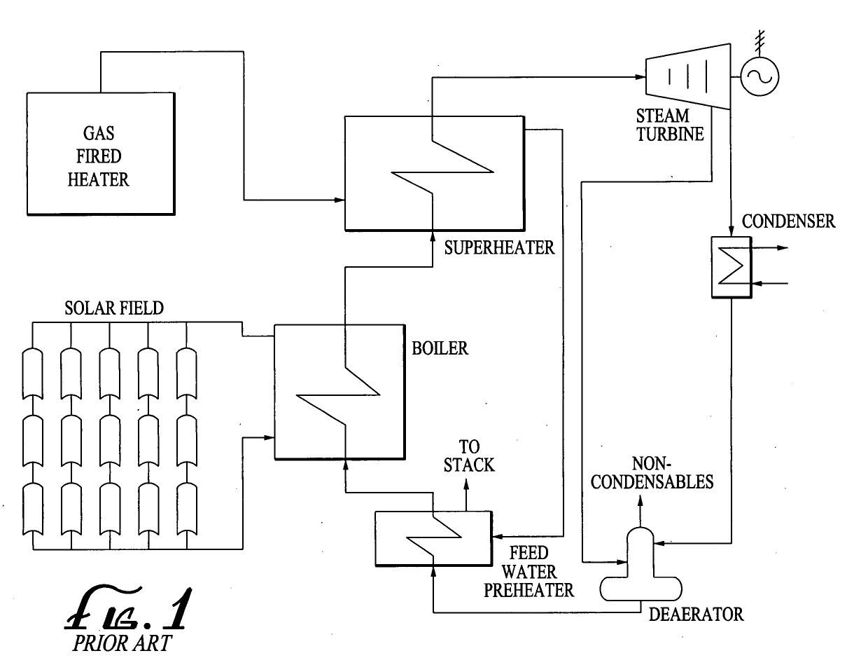

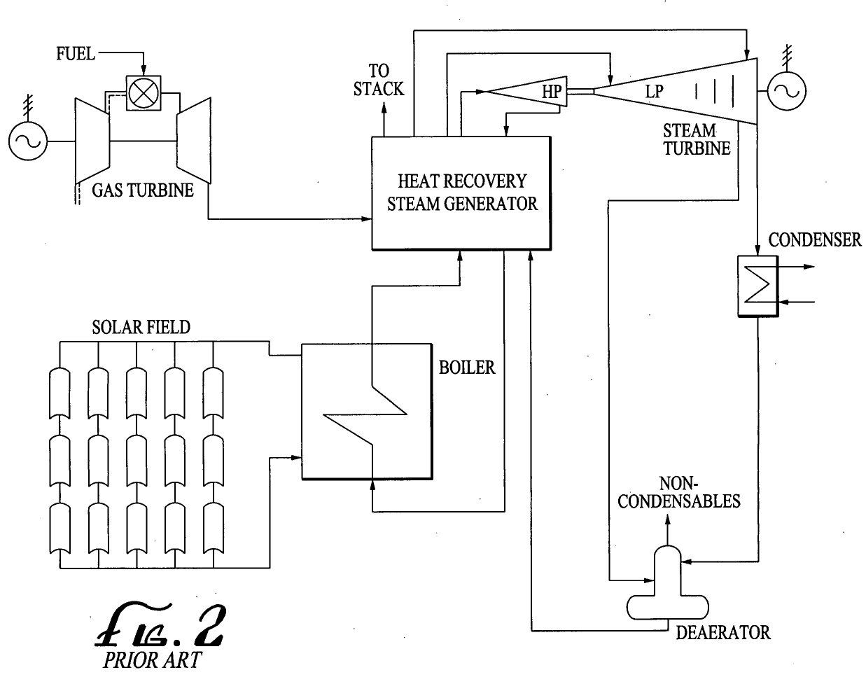

A hypothetical solar thermal regeneration system, such as illustrated in FIG. 1, was compared with a hypothetical ISCCS, such as illustrated in FIG. 2, and a hypothetical system of the invention, such as illustrated in FIG. 3.

In each hypothetical case, the solar field is estimated to be 540,000 square meters, capable of producing about 940 million BTU's per hour at peak on a summer day in a typical high solar insolation area.

The fossil fuel-fired heater in the solar thermal regeneration system illustrated in FIG. 1 is assumed to be 100 MW in size. The gas turbine electric generator in the ISCCS system is assumed to be 325 MW. The gas turbine electric generator in the apparatus of the invention as illustrated in FIG. 3 is assumed to be 247 MW.

The working gas vapor turbine electric generator used in the solar thermal regeneration system illustrated in FIG. 1 is assumed to be 100 MW in size. The working fluid vapor turbine electric generator in the ISCCS is assumed to be 295 MW and the working fluid vapor turbine electric generator in the system of the invention is assumed to be 373 MW. The gas combustion turbine electric generator is assumed to produce about 1.7 billion BTUs per hour of exhaust heat in the ISCCS and is assumed to produce about 1.3 billion BTUs per hour of waste heat in the system of the invention.

The efficiency in terms of fossil fuel only (defined as the net or incremental heat rate based upon the amount of energy generated by fossil fuel only and without including any sore heat contribution) for the solar thermal regeneration system illustrated in FIG. 1 is 37%, for the ISCCS 56.5% and for the system of the invention 57.5%.

The combined efficiency (defined as total energy production divided by the fossil fuel input based upon lower heating value and including the solar heat contribution) for the solar thermal regeneration system illustrated in FIG. 1 is 75%, for the ISCCS 69% and for the system of the invention 85%.

The ratio of solar energy to energy produced by fossil fuels on an instantaneous basis for the solar thermal regeneration system illustrated in FIG. 1 is 5:1, for the ISCCS 1:6 and for the system of the invention 1:3.

The ratio of energy derived from fossil fuel to the quantity of solar energy produced on a yearly average for the solar thermal regeneration system illustrated in FIG. 1 is 4:1, for the ISCCS is 1:14 and for the system of the invention 1:1.5.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A method for generating electricity comprising the steps of:
(a) combusting a fuel gas in a gas turbine electric generator to produce a hot exhaust gas and a first quantity of electricity;
(b) heating a solar energy transfer fluid with solar energy collected in a solar collector array;
(c) heating a working fluid liquid in a vaporizer with the solar energy transfer fluid to vaporize the working fluid liquid, thereby producing a working fluid vapor at a first working fluid vapor temperature;
(d) transferring the working fluid vapor to one or more superheaters and therein heating the working fluid vapor with the exhaust gas from the gas turbine electric generator to heat the working fluid vapor to a second working fluid vapor temperature which is higher than the first working fluid vapor temperature;
(e) driving a working fluid vapor turbine electric generator with the working fluid vapor after it has been heated to the second working fluid vapor temperature to yield a second quantity of electricity and exhaust working fluid vapor having a third temperature which is lower than the second working fluid vapor temperature;
wherein all of the working fluid vapor heated to the second working fluid vapor temperature in step (d) is produced in step (c).

2. The method of claim 1 wherein the working fluid vapor is heated from the first working fluid vapor temperature to the second working fluid vapor temperature in the one or more superheaters in step (d) by thermal contact with at least about 90% of the hot exhaust gas from the gas turbine electric generator.

3. The method of claim 1 wherein the working fluid vapor is heated from the first working fluid vapor temperature to the second working fluid vapor temperature in the one or more superheaters in step (d) by thermal contact with at least about 95% of the hot exhaust gas from the gas turbine electric generator.

4. The method of claim 1 wherein the working fluid vapor is heated from the first working fluid vapor temperature to the second working fluid vapor temperature in the one or more superheaters in step (d) by thermal contact with about 100% of the hot exhaust gas from the gas turbine electric generator.

5. The method of claim 1 wherein the exhaust working fluid vapor is condensed, preheated in a preheater and recycled to the vaporizer and wherein essentially all of the exhaust gas from the gas turbine electric generator is removed from the one or more superheaters and used to heat condensed exhaust working fluid vapor in the preheater.

6. The method of claim 1 wherein the exhaust working fluid vapor is condensed, preheated in a preheater and recycled to the vaporizer and wherein all of the exhaust gas from the gas turbine electric generator is removed from the one or more superheaters and used to heat condensed exhaust working fluid vapor in the preheater.

7. An apparatus for generating electricity comprising:
(a) a gas turbine electric generator for generating a first quantity of electricity and yielding a hot exhaust gas;
(b) a solar energy collector array for collecting solar energy and transferring that solar energy to a solar energy transfer fluid;
(c) a vaporizer in fluid communication with a source of a working fluid liquid and in thermal communication with the solar energy transfer fluid such that working fluid liquid disposed within the vaporizer can be heated to a working fluid vapor by thermal contact with the solar energy transfer fluid;
(d) one or more superheaters in fluid communication with the vaporizer for receiving working fluid vapor generated in the vaporizer, the one or more superheaters being in thermal communication with the exhaust gas from the gas turbine electric generator so that working fluid vapor received into the superheater can be further heated in the superheater; and
(e) a working fluid vapor turbine electric generator, the working fluid vapor turbine electric generator being in fluid communication with the working fluid vapor from the one or more superheaters so that working fluid vapor from the one or more superheaters can be used to drive the working fluid vapor turbine electric generator, thereby to generate a second quantity of electricity;
wherein all of the working fluid vapor exiting the one or more superheaters is that which is produced in the vaporizer.

8. The apparatus of claim 7 wherein all of the hot exhaust gas produced in the gas turbine electric generator is in thermal contact with the one or more superheaters.

9. The apparatus of claim 7 further comprising (i) a preheater for condensing working fluid vapor flowing from the working fluid vapor turbine electric generator, and (ii) a preheater for heating condensed working fluid vapor from the condenser, the preheater being in thermal contact with essentially all of the exhaust gas flowing from the one or more superheaters.

10. The apparatus of claim 7 further comprising (i) a preheater for condensing working fluid vapor flowing from the working fluid vapor turbine electric generator, and (ii) a preheater for heating condensed working fluid vapor from the condenser, the preheater being in thermal contact with all of the exhaust gas flowing from the one or more superheaters.
